(19) United States
(12) Patent Application Publication
(10) Pub. No.: US 2026/0223181 A1
(43) Pub. Date: Jul. 30, 2026

(54) RANDOM ACCESS CHANNEL (RACH) TRANSMISSION BASED ON MULTIPLE SYNCHRONIZATION SIGNAL BLOCKS

(71) Applicant: Apple Inc., Cupertino, CA (US)

(72) Inventors: Lijie ZHANG, Beijing (CN); Dongzhou YANG, Beijing (CN); Zhiwei WANG, Beijing City (CN)

(21) Appl. No.: 19/143,279

(22) PCT Filed: Jan. 10, 2023
(86) PCT No.: PCT/CN2023/071633

§ 371 Date: Jun. 25, 2025

(51) Int. Cl. H04W 74/0833; H04W 24/08; H04W 74/08

(52) U.S. Cl. CPC H04W 74/0833; H04W 24/08; H04W 74/0891

(57) ABSTRACT

This application regards a wireless device transmitting random access channel (RACH) transmissions based on multiple synchronization signal (SS) blocks. The wireless device divides an SS block burst set into multiple SS block groups, each SS block group including multiple SS blocks. The wireless device measures and selects a strongest SS block as a group serving SS block for each SS block group. The wireless device can maintain timing and frequency tracking for multiple group serving SS blocks, and responsive to a trigger for a RACH procedure, select one or more RACH occasions, each RACH occasion associated with a different SS block group, and transmit physical RACH (PRACH) preambles during the one or more RACH occasions. The wireless device can also monitor for random access response (RAR) messages during for each of the PRACH preambles and discontinue monitoring after receipt of an RAR message corresponding to one of the PRACH preambles.

### FIELD

The described embodiments relate to wireless communications, including methods and apparatus to send random access channel (RACH) transmissions based on multiple synchronization signal (SS) blocks by a wireless device.

### BACKGROUND

Newer generation, e.g., fifth generation (5G) new radio (NR), cellular wireless networks that implement one or more 3rd Generation Partnership Project (3GPP) 5G standards are rapidly being developed and deployed by network operators worldwide. The newer cellular wireless networks provide a range of packet-based services, with 5G technology providing increased data throughput and lower latency connections that promise enhanced mobile broadband services for wireless devices. The higher data throughput and lower latency promised by 5G is expected to usher in a range of new applications and services as well as improve existing ones. Users expect higher quality for services provided by newer 5G technology. Latency incurred while performing certain procedures, such as during a random access channel (RACH) procedure to synchronize a wireless device with a cellular wireless network, can impact a user's experience. For example, voice quality can degrade during a voice handover affected by RACH latency, and an amount of time required to adjust services can be impacted. There exists a need for mechanisms for wireless devices to use multiple synchronization signal (SS) blocks transmitted by a cellular wireless network to reduce latency associated with a RACH procedure.

### SUMMARY

This application relates to wireless communications, including methods and apparatus to send random access channel (RACH) transmissions based on multiple synchronization signal (SS) blocks by a wireless device. 5G NR technology allows for transmission of multiple SS blocks by a cellular wireless network entity, e.g., a gNodeB. The cellular wireless network entity can transmit a set of SS blocks sequentially using a set of distinct directional transmit beams to cover a wide area, e.g., transmit beam-sweeping to provide spatially directional transmission diversity. The cellular wireless network entity can indicate a random access configuration in a system information block type 1 (SIB-1) message broadcast to wireless devices. The random access configuration includes a first parameter that specifies how many SS blocks map to each RACH occasion, and a second parameter that specifies the number of contention based (CB) preambles per SS block per valid RACH occasion. Each SS block maps to a particular RACH occasion, and in some cases, multiple SS blocks can map to the same RACH occasion on which to transmit a preamble to initiate a RACH procedure. The set of SS blocks can be divided into distinct, non-overlapping SS block groups, each SS block group being associated with a different set of RACH occasions. For example, the set of SS blocks can include eight SS blocks that divide into two groups of four SS blocks each, where each SS block group maps to different RACH occasions. The wireless device can measure performance metrics for each SS block received from the cellular wireless network and can determine an SS block for each SS block group that has a strongest measured performance metric. The determined SS block with the strongest performance can be designated as a group serving SS block for the SS block group. The wireless device can maintain downlink (DL) timing and frequency tracking for each group serving SS block. In some cases, only those group serving SS blocks having a measured performance metric that satisfies a performance threshold are tracked. The wireless device can use a RACH occasion associated with any group serving SS block for which the measured performance metric satisfies the performance threshold for transmission of a preamble to a cellular wireless network to initiate a RACH procedure (assuming sufficient time exists to prepare and transmit the preamble during the RACH occasion). In some embodiments, the wireless device selects a RACH occasion nearest in time to a RACH triggering event for which a group serving SS block satisfies the performance threshold and for which sufficient time is available to prepare and transmit the physical RACH (PRACH) preamble to the cellular wireless network to initiate a RACH procedure with the cellular wireless network. In some cases, the RACH occasion nearest in time to the RACH triggering event is used for the PRACH preamble transmission. In some cases the RACH occasion second closest in time to the RACH triggering event is used for the PRACH preamble transmission. In some embodiments, SS block indices are assigned to SS blocks to provide broad spatially directional transmit diversity for each SS block group. In some cases, SS blocks associated with adjacent transmit beams are assigned SS block indices to distribute the SS blocks into different SS block groups. In some embodiments, the wireless device transmits multiple preambles to initiate a RACH procedure, each preamble associated with a different SS block group and a different associated RACH occasion. The wireless device can monitor for random access response (RAR) messages for each of the transmitted preambles until an RAR message is received from the cellular wireless network in response to one of the transmitted preambles. The wireless device can respond to the RAR message (as part of a 4-step RACH procedure) and can cancel monitoring RAR messages for the other transmitted preambles.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of communication for a random access channel (RACH) procedure between a wireless device and a cellular wireless network, according to some embodiments.

FIG. 2 illustrates a diagram of a format for a synchronization signal (SS) block transmitted by a cellular wireless network, according to some embodiments.

FIG. 3 illustrates an exemplary grouping of synchronization signal (SS) blocks into SS block burst sets and association of SS blocks with different transmit beams, according to some embodiments.

FIG. 4, illustrates a frame format that includes multiple RACH occasions grouped into particular sub-frames, according to some embodiments.

FIG. 5A illustrates a diagram of an example of latency incurred to initiate a RACH procedure by a wireless device, according to some embodiments.

FIG. 5B illustrates diagrams of an example of channel fading impacting a RACH procedure by a wireless device, according to some embodiments.

FIG. 5C illustrates a diagram of an example of reduced latency incurred to initiate a RACH procedure by a wireless device, according to some embodiments.

FIG. 5D illustrates diagrams of exemplary synchronization signal (SS) block groupings based on mapping of SS block indices, according to some embodiments.

FIG. 5E illustrates a diagram of an example of a wireless device transmitting multiple preambles to initiate a RACH procedure, according to some embodiments.

FIG. 6 illustrates a flowchart of an exemplary method of using multiple SS blocks to improve RACH performance by a wireless device, according to some embodiments.

FIG. 7 illustrates a block diagram of exemplary elements of a wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

This application relates to wireless communications, including methods and apparatus to send random access channel (RACH) transmissions based on multiple synchronization signal (SS) blocks by a wireless device. 5G NR technology allows for transmission of multiple SS blocks by a cellular wireless network entity, e.g., a gNodeB, of a cellular wireless network. The gNodeB can transmit a set of SS blocks sequentially using a set of distinct directional transmit beams to cover a wide spatial area, e.g., transmit beam-sweeping to provide spatially directional transmission diversity. Each SS block is assigned an SS block index and can be associated with a different transmit beam. The gNodeB can broadcast a random access configuration in a system information block type 1 (SIB-1) message indicating parameters for random access communication between the gNodeB of the cellular wireless network and wireless devices. The random access configuration can include a first parameter that specifies how many SS blocks map to a single RACH occasion, where the first parameter can vary from a fractional number less than one, e.g., ⅛, where each SS block is associated with multiple RACH occasions, to an integer power of two, e.g., 4, where four different SS blocks are associated with a single RACH occasion. The random access configuration can also include a second parameter that specifies the number of contention based (CB) preambles per SS block per valid RACH occasion. Multiple CB preambles can be available for each unique SS block.

The set of all available SS blocks map to distinct RACH occasions, and in some cases, multiple SS blocks can map to the same RACH occasion to use as part of a multi-step (e.g., 2-step or 4-step) RACH procedure. The set of SS blocks can be divided into SS block groups, each SS block group being associated with a different set of RACH occasions, which recur periodically in different uplink (UL) transmit frames. For example, the set of SS blocks can include eight SS blocks that can be divided into two groups of four SS blocks each, where each SS block group maps to a distinct set of RACH occasions. The wireless device measures performance metrics for each SS block received from the cellular wireless network and determines, from each SS block group, an SS block that has a strongest measured performance metric, where the determined SS block is designated as a group serving SS block for the associated SS block group. Dividing the set of SS blocks and selecting an SS block from each SS block group differs from previous RACH procedures that select only a single SS block from the set of SS blocks. Multiple SS blocks that belong to different SS block groups map to different RACH occasions, which allows the wireless device flexibility in selecting a RACH occasion during which to initiate a RACH procedure by transmitting a physical RACH (PRACH) preamble during the selected RACH occasion.

The wireless device can maintain downlink (DL) timing and frequency tracking for each group serving SS block. In some cases, only those group serving SS blocks that have a measured performance metric that satisfies a performance threshold are tracked, e.g., those group serving SS blocks for which a signal strength and/or a signal quality meet performance thresholds indicating a strong likelihood of success for reception of transmission on RACH occasions associated with the group serving SS blocks. The wireless device can use a RACH occasion associated with any group serving SS block for which the measured performance metric satisfies the performance threshold. In some embodiments, the wireless device selects a RACH occasion nearest in time to a RACH triggering event for which a group serving SS block satisfies the performance threshold and for which sufficient time is available to prepare and transmit the PRACH preamble to the cellular wireless network to initiate the RACH procedure with the cellular wireless network. In some cases, the RACH occasion selected by the wireless device for the PRACH preamble transmission is nearest in time to the RACH triggering event. In some cases, the RACH occasion selected by the wireless device for the PRACH preamble transmission is second closest in time to the RACH triggering event, i.e., not the first RACH occasion available after the RACH triggering event but the second RACH occasion available after the RACH triggering event.

In some embodiments, SS block indices are assigned to SS blocks to provide broad spatially directional transmit diversity for each SS block group. In some embodiments, SS block indices are assigned sequentially to different SS block groups in a round-robin fashion to distribute the SS block indices among different SS block groups, where the cellular wireless network also assigns the SS block indices sequentially in a round-robin fashion to different transmit beams. In some cases, SS blocks associated with adjacent transmit beams are assigned SS block indices to distribute the SS blocks into different SS block groups.

In some embodiments, the wireless device transmits multiple preambles during distinct RACH occasions to initiate a RACH procedure, where each RACH occasion is associated with a different SS block group. Each preamble can be associated with an SS block from a distinct SS block group that maps to a distinct RACH occasion. Rather than sending a single preamble during a single RACH occasion to initiate the RACH procedure, the wireless device transmits multiple preambles during multiple RACH occasions, thereby increasing transmit diversity (in time), and each preamble is associated with a different SS block (which is therefore also associated with a different transmit beam from the cellular wireless network). The wireless device monitors for random access response (RAR) messages from the cellular wireless network for each of the transmitted preambles until an RAR message is received from the cellular wireless network in response to one of the transmitted preambles. The wireless device can respond to the RAR message (to continue steps of a 4-step RACH procedure) and cancels monitoring RAR messages for the other transmitted preambles.

These and other embodiments are discussed below with reference to FIGS. 1 through 7; however, those skilled in the art will readily appreciate that the detailed description given herein with respect to these figures is for explanatory purposes only and should not be construed as limiting.

FIG. 1 illustrates a block diagram 100 of communication between a wireless device 102 and a gNodeB 112 for a 5G NR random access channel (RACH) procedure. The wireless device 102 can determine a future RACH occasion on which to transmit a preamble to the gNodeB 112 based on measurements of synchronization signal (SS) blocks received from the gNodeB 112. Each SS block can be associated with a corresponding RACH occasion, and the wireless device 102 can select a RACH occasion for a received SS block that satisfies a performance threshold. At 104, The wireless device 102 transmits a physical RACH (PRACH) preamble to the gNodeB 112 during the selected RACH occasion. The wireless device 102 can repeatedly send the PRACH preamble to the gNodeB 112 with increasing transmit power levels until receiving a response from the gNodeB 112. At 106, the wireless device 102 receives a random access response (RAR) message from the gNodeB 112 indicating that the cellular wireless network received the PRACH preamble. The RAR message can include a timing advance (TA) command to indicate to the wireless device 102 to adjust alignment of uplink (UL) transmissions. At 108, the wireless device transmits an uplink message, designated “message 3”, to the gNodeB 112, and at 110, the gNodeB 112 responds with a downlink message, designated “message 4”. The four-step RACH procedure illustrated in FIG. 1 is used by the wireless device 102 to acquire timing and synchronize transmissions with the gNodeB 112 to allow for contention-free communication with the cellular wireless network.

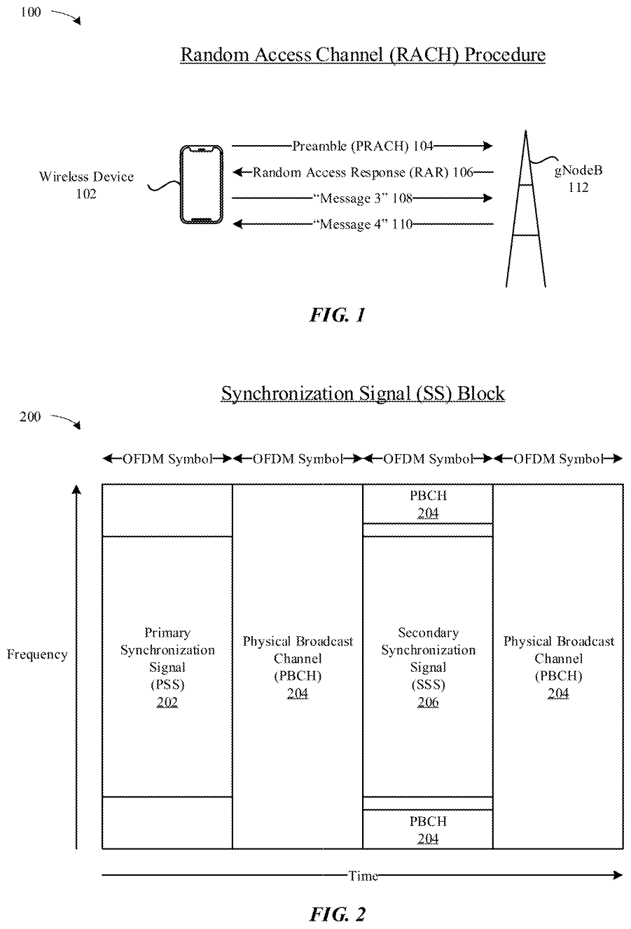

FIG. 2 illustrates a diagram of a representative format for a synchronization signal (SS) block 200 transmitted by a gNodeB 112 to wireless devices 102. The SS block 200 spans four consecutive orthogonal frequency division multiplexing (OFDM) symbols and includes a primary synchronization signal (PSS) 202 in the first OFDM symbol of the SS block and a secondary synchronization signal (SSS) 206 in the third OFDM symbol of the SS block. The wireless device 102 can use the PSS 202 and SSS 206 to identify a cellular wireless network and synchronize with the gNodeB 112 of the cellular wireless network. The SS block 200 also includes a physical broadcast channel (PBCH) 204 in the second and fourth OFDM symbols, as well as in select frequency subcarriers of the third OFDM symbol. The PBCH 204 includes system information in a master information block (MIB) and indicates where additional broadcast system information (SI), e.g., SI block type 1 (SIB-1), can be obtained by the wireless device 102. The SS block 200 is transmitted by the gNodeB 112 periodically with a typical spacing of 20 ms between successive SS blocks 200 associated with a particular transmit beam.

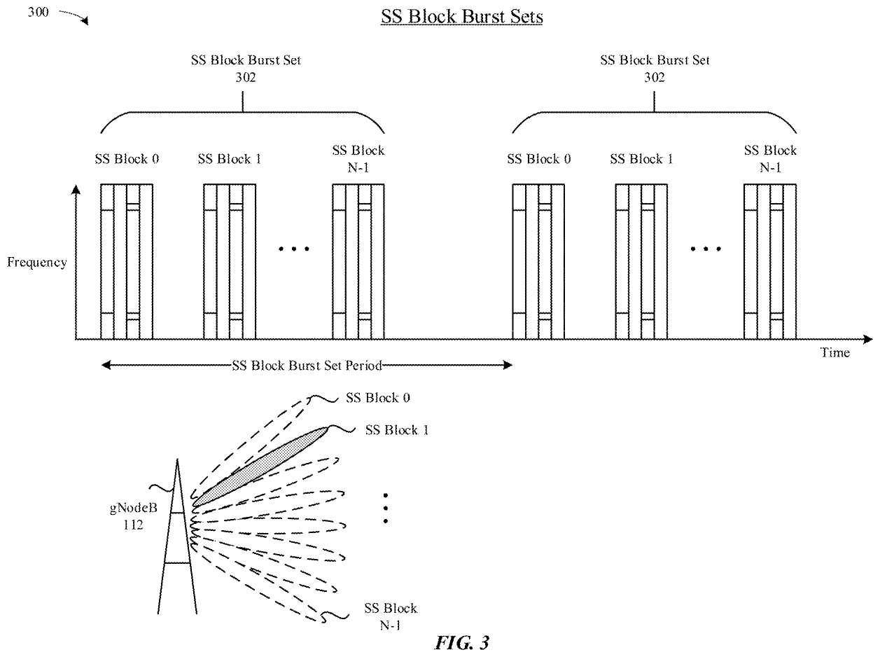

FIG. 3 illustrates a diagram 300 of exemplary SS block burst sets 302 transmitted by a gNodeB 112. The gNodeB 112 can transmit successive SS blocks 200 using transmit beam sweeping across an SS block burst set 302 to provide a wider spatial coverage, where each SS block 200 is transmitted on a different transmit beam in a different direction. The SS blocks are arranged into SS block burst sets 302 that each include N SS blocks, where each SS block is labeled with an SS block index, e.g., SS block 0, followed by SS block 1, etc. Successive SS blocks can be transmitted sequentially by the gNodeB 112 on different transmit beams in a round-robin fashion, each SS block burst set 302 returning to an initial transmit beam for transmission of the first SS block 200 in the SS block burst set 302. SS block burst sets 302 repeat with an SS block burst set periodicity, and successively transmitted SS blocks 200 having identical SS block indices are separated by the same time interval as the SS block burst set period. For example, SS block 0 in the first SS block burst set 302 and SS block 0 in the second SS block burst set 302 are transmitted apart in time by the SS block burst set period. Similarly, SS block 1 in the first SS block burst set 302 is separated from SS block 1 in the second SS block burst set 302 by the same time interval. Shorter SS block burst set periodicity allows for faster cell search by a wireless device 102 but requires more frequent transmissions by the gNodeB 112, which consumes power, while longer SS block burst set periodicity allows for greater energy efficiency but longer times for cell acquisition by wireless devices 102. The number of SS blocks 200 within an SS block burst set 302 can depend on a frequency range used by the gNodeB 112, where lower frequency ranges can use fewer SS blocks 200 per SS block burst set 302, and higher frequency ranges can use more SS blocks 200 per SS block burst set 302. The PBCH 204 of each SS block 200 includes an SS block index value to indicate the position of the SS block 200 within an SS block burst set 302. Different SS blocks 200 having different SS block indices are transmitted on different transmit beams and can be associated with different RACH occasions. The PBCH 204 includes the MIB, which can indicate to the wireless device 102 additional broadcast system information (SI) messages, e.g., SI block type 1 (SIB-1) messages, that include information specifying a random access configuration used by the gNodeB 112 of the cellular wireless network. Exemplary random access configuration parameters include physical RACH (PRACH) preamble patterns and time/frequency resources for RACH occasions, allowable PRACH preamble transmit power levels, and a mapping from SS block index values to RACH occasions. The wireless device 102 can receive SS block burst sets 302, calculate and select a strongest SS block 200 that satisfies a performance threshold, determine a RACH occasion to which the selected SS block 200 maps, select a PRACH preamble applicable to the SS block 200 and RACH occasion, and transmit the PRACH preamble on the selected RACH occasion.

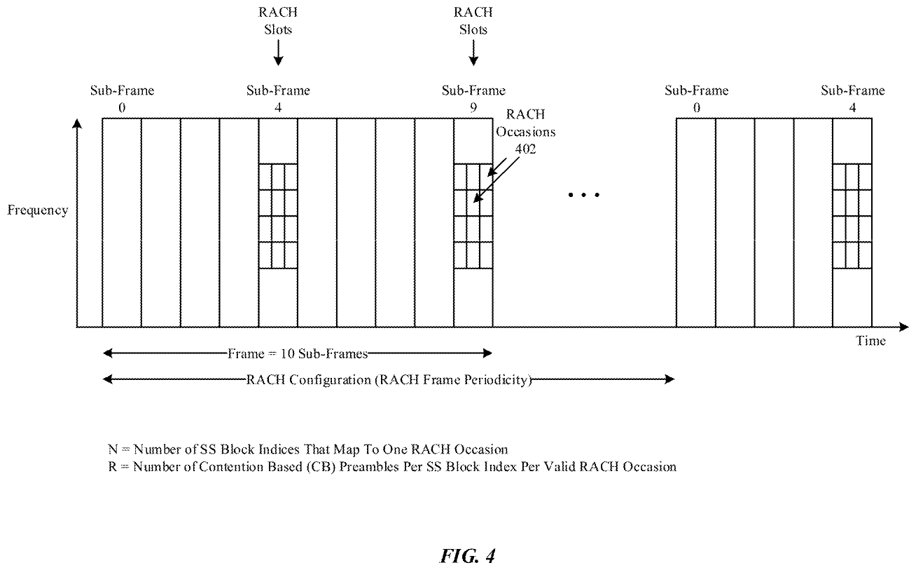

FIG. 4 illustrates a diagram 400 of RACH occasions 402 in uplink (UL) transmit frames available for UL transmission by a wireless device 102 to a gNodeB 112 of a cellular wireless network. The RACH configuration for mapping SS block 200 indices to RACH occasions 402 is broadcast by the gNodeB 112 to wireless devices in SIB-1 messages. The RACH configuration specifies time/frequency resources for RACH slots in which RACH occasions 402 can occur in a frame and a RACH frame periodicity, which can vary from one frame (i.e., RACH slots occur in every frame) to 16 frames (i.e., RACH slots occur in every 16^{th} frame). The number of RACH slots available in a given frame is also specified in the RACH configuration, and each RACH slot can include multiple RACH occasions 402. The RACH configuration further indicates the number N of SS block 200 indices that map to a single RACH occasion 402, and the number R of contention based (CB) preambles per SS block 200 index value per valid RACH occasion 402. Different wireless devices 102 can select the same RACH occasion 402 on which to initiate a RACH procedure and can each randomly select a CB preamble applicable to the selected RACH occasion 402 to use when transmitting on the selected RACH occasion 402. In a typical RACH configuration as shown in FIG. 4, RACH occasions 402 are available in RACH slots of sub-frames 0 and 9 of a frame, and reoccur with a RACH frame periodicity indicated by the gNodeB 112 of the cellular wireless network. The number of SS blocks 200 that map to a RACH occasion 402 specified in the RACH configuration broadcast by the gNodeB 112 can range from ⅛ (where each SS block 200 maps to 8 different RACH occasions 402) to 16 (where 16 different SS blocks 200 map to the same RACH occasion 402). The embodiments described herein apply to scenarios in which multiple SS blocks 200 map to the same RACH occasion 402.

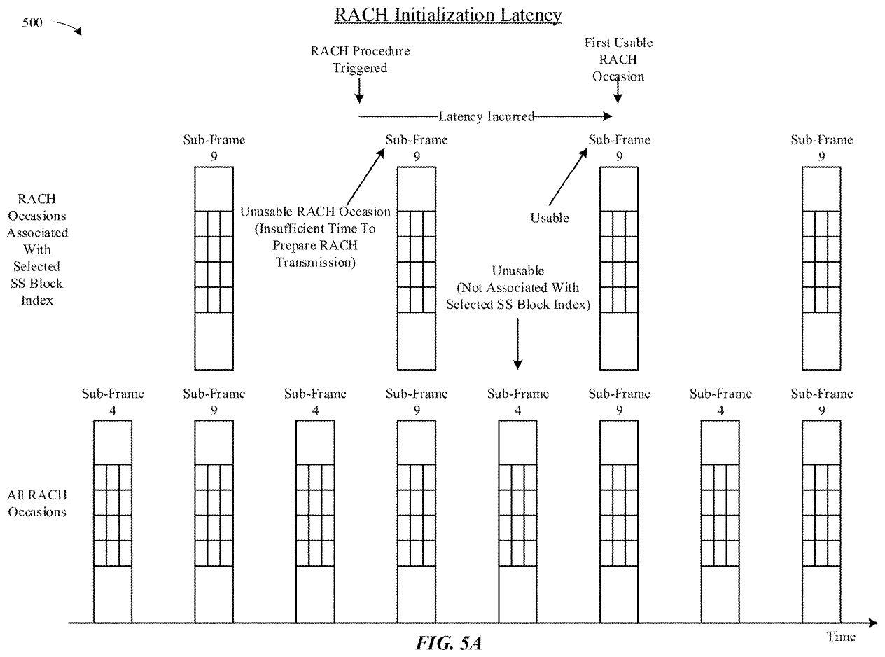

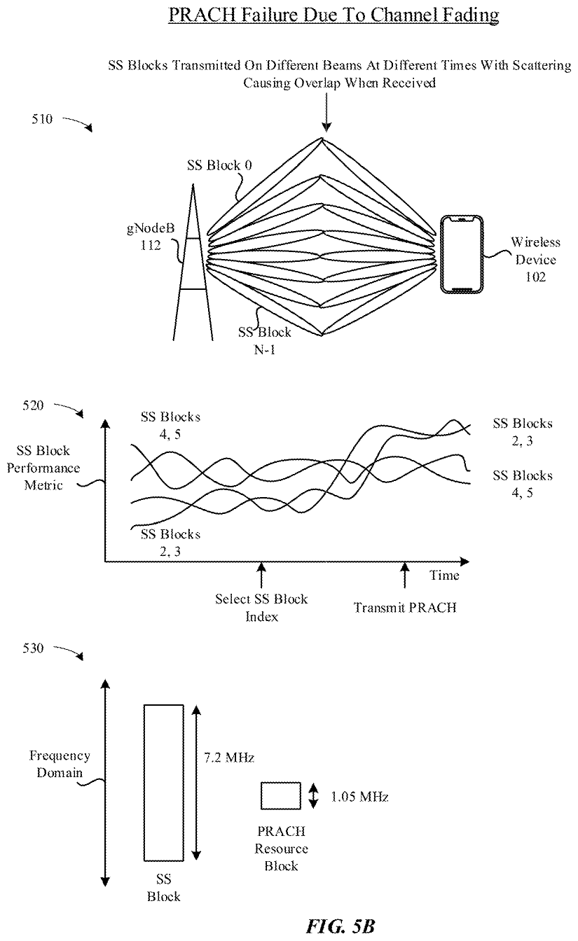

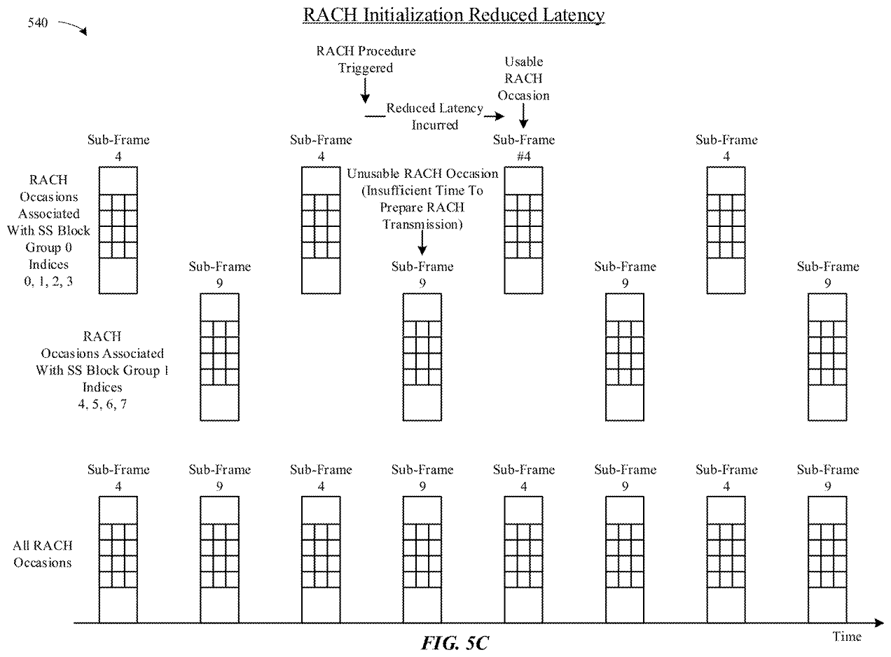

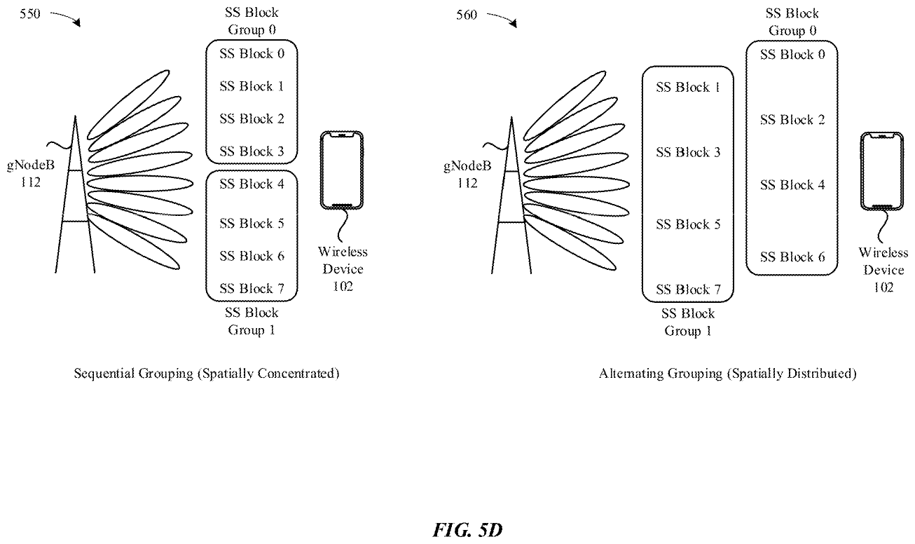

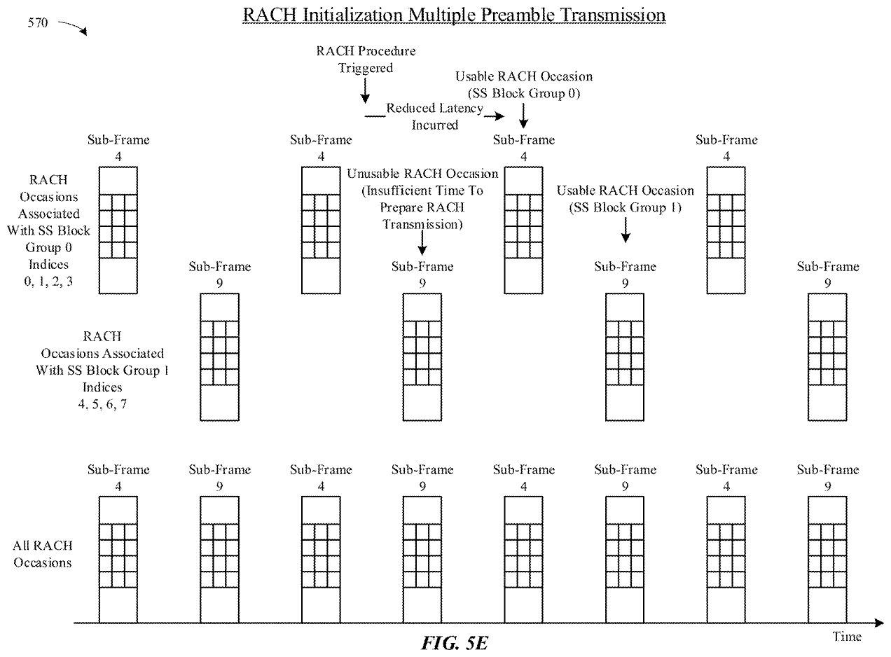

FIG. 5A illustrates a diagram 500 of an example of latency incurred by a wireless device 102 when initiating a RACH procedure. In an exemplary implementation, each SS block burst set 302 includes eight SS blocks 200, and four different SS blocks 200 map to the same RACH occasion 402. As such, the SS block burst set 302 can be divided into two SS block groups of four SS blocks 200 each, each SS block group associated with a different RACH occasion 402. RACH occasions 402 occur in sub-frames 4 and 9. The wireless device 102 can measure SS blocks 200 received from the gNodeB 112 of the cellular wireless network, and responsive to a trigger to initiate a RACH procedure, select an SS block 200 that measures the strongest and satisfies a performance threshold. In the example of FIG. 5A, the selected SS block 200 is associated with RACH occasions 402 that occur in sub-frames 9. The wireless device 102 requires a minimum amount of time after the triggering of the RACH procedure to select a PRACH preamble and prepare for transmission of the PRACH preamble to the gNodeB 112 during a RACH occasion in a sub-frame 9. In the example illustrated by FIG. 5A, the trigger for the RACH procedure occurs close in time to the next sub-frame 9, and therefore there is insufficient time to prepare the PRACH preamble transmission by the wireless device 102. A RACH occasion 402 in the next sub-frame 9 instead can be used for sending the PRACH preamble to the gNodeB 112; however, depending on a spacing between frames that include RACH occasions 402, e.g., successive frames with RACH occasions 402 can occur every 10 ms or up to 160 ms apart, significant latency can be incurred before the RACH procedure starts. Moreover, RACH occasions 402 in sub-frame 4, which occurs earlier than the used sub-frame 9 RACH occasion 402, is not used, because the selected SS block 200 is mapped to RACH occasions 402 that only occur in sub-frame 9. Restricting the wireless device 102 to select only a single SS block 200 can result in increased latency to initiate a RACH procedure.

FIG. 5B illustrates a diagram 510 of time-frequency domain fading causing a PRACH preamble transmission transmitted by a wireless device 102 to fail to reach a gNodeB 112 of a cellular wireless network. The gNodeB 112 transmits different SS blocks 200 of an SS block burst set 302 using different directional transmit beams. For a seriously scattering communication channel between the gNodeB 112 and the wireless device 102, multiple SS blocks 200 can arrive at the wireless device 102 in overlapping scattering clusters. SS blocks 200 transmitted on different beams at different times via a scattering channel can overlap in time when arriving at the wireless device 102. The wireless device 102 selects a group serving SS block having measurements that satisfy a performance threshold, and to avoid ping-pong switching between different SS blocks 200 when fast fading in the communication channel between the wireless device 102 and the gNodeB 112 can cause the measured performance of the SS blocks 200 to vary rapidly, the wireless device 102 can switch to another stronger SS block 200 only after an amount of time, e.g., based on a hysteresis timer, elapses. With deep fading, a group serving SS block previously selected may not be the strongest SS block 200 beam during the associated RACH occasion 402 during which the PRACH preamble is transmitted, and the PRACH preamble may fail to be received by the gNodeB 112 due to the deep fading. As shown in diagram 520, the wireless device 102 can select SS block 200 with SS block index 4 or 5 at a first time and transmit a PRACH preamble during a RACH occasion 402 associated with the SS block index 4 or 5 at a future time when SS blocks 200 with SS block indices 2 and 3 have higher performance than SS blocks 4 and 5. The delay due to hysteresis (and waiting for an appropriate RACH occasion 402) can cause the wireless device 102 to use a RACH occasion 402 of a sub-optimal performing SS block 200 to transmit the PRACH preamble to the gNodeB 112. In addition, as shown in diagram 530, the time-frequency resource block available for the PRACH preamble transmission can span a much narrower range of frequencies than the SS blocks 200 measured by the wireless device 102 to select an SS block 200 and associated RACH occasion 402 on which to transmit the PRACH preamble. Frequency selective fading can impact the PRACH preamble more severely than the SS block 200, and therefore the measured SS block 200 by which the wireless device 102 estimates communication channel performance, may not reflect conditions for the PRACH preamble transmission, which may fail to be received by the gNodeB 112 when deep fading occurs.

FIG. 5C illustrates a diagram 540 of an example of a wireless device 102 using multiple SS blocks 200 associated with distinct RACH occasions 402 to reduce latency to initiate a RACH procedure. A gNodeB 112 of a cellular wireless network transmits SS block burst sets 302 that include eight SS blocks 200 transmitted at different times sequentially on different transmit beams in different directions. The eight SS blocks 200 map to two different sets of RACH occasions 402. A first set of RACH occasions 402 is associated with a first SS block group 0 that includes SS blocks 200 with indices 0, 1, 2, and 3 occur in sub-frames 4 of frames that include RACH occasions 402. A second set of RACH occasions 402 is associated with a second SS block group 1 that includes SS blocks 200 with indices 4, 5, 6, and 7 and occur in sub-frames 9 of frames that include RACH occasions 402. The wireless device 102 can select multiple SS blocks 200 that measure with sufficient signal strength/quality to satisfy a performance threshold and use a RACH occasion 402 associated with one of the multiple SS blocks 200 that occurs nearest in time to occurrence of a trigger for a RACH procedure and with sufficient time to prepare and transmit the PRACH preamble on the RACH occasion 402 for the selected SS block 200. In the example illustrated by FIG. 5C, the wireless device 102 can select an SS block 200 from SS block group 0 associated with RACH occasions 402 that occur in sub-frame 4 and incur less latency to initiate the RACH procedure than using an SS block 200 from SS block group 1 associated with RACH occasions 402 that occur in sub-frame 9, which would incur more latency to initiate the RACH procedure as shown in FIG. 5A. While the example of FIG. 5C divides the SS blocks 200 into two SS block groups of four SS blocks 200 each, a different RACH configuration could specify two SS blocks 200 per RACH occasion 402, and the wireless device 102 could divide the SS blocks 200 into four SS block groups of two SS blocks 200 each, select an SS block 200 that satisfies the performance threshold from any of the four SS block groups, and transmit the PRACH preamble on the RACH occasion 402 associated with the selected SS block 200. If no SS blocks 200 within an SS block group satisfy the performance threshold, then the wireless device 102 does not select an SS block 200 from that SS block group. In some embodiments, the wireless device 102 selects the strongest SS block 200 from each SS block group as a group serving SS block and can use a RACH occasion 402 associated with the group serving SS block, if the group serving SS block satisfies the performance threshold. When multiple group serving SS blocks are available and satisfy the performance threshold, the wireless device 102 can maintain downlink timing and frequency tracking based on each group serving SS block. When a RACH procedure is triggered, the wireless device 102 can select the group serving SS block associated with the nearest RACH occasion 402 to the trigger (and with sufficient time to prepare and transmit the PRACH preamble to the gNodeB 112).

FIG. 5D illustrates diagrams 550, 560 of examples of mapping SS block 200 indices to SS block groups. Each SS block 200 of an SS block burst set 302 is transmitted by the gNodeB 112 using a different transmit beam concentrated in a different direction to provide wide spatial coverage by the SS block burst set 302 as a whole. A RACH configuration broadcast by the gNodeB 112 indicates the number of SS blocks 200 that map to a single RACH occasion 402. In the example of FIG. 5D, four SS blocks 200 map to each RACH occasion 402, and the SS block burst set 302 is divided into two SS block groups. In the diagram 550, the SS block burst set 302 is divided into SS block group 0 associated with SS block indices 0, 1, 2, and 3, and SS block group 1 associated with SS block indices 4, 5, 6, and 7. This arrangement dividing the SS blocks sequentially into SS block groups with consecutive SS block indices results in SS block groups with spatially concentrated transmit beam patterns, which can result in SS blocks 200 in SS block group 0 to differ substantially in performance from SS blocks 200 in SS block group 1, where SS block group 0 can encounter different communication channel conditions from SS block group 1. In diagram 560, the SS block burst set 302 is divided into SS block group 0 associated with SS block indices 0, 2, 4, and 6, and SS block group 1 associated with SS block indices 1, 3, 5, and 7. This arrangement dividing the SS blocks 200 using alternating grouping results in SS block groups with similar spatially distributed transmit beam patterns, which can result in similar performance for SS blocks 200 in SS block group 0 to SS blocks 200 in SS block group 1. It is preferable to have comparable spatial transmit beam diversity in each SS block group, to improve the chances that at least one SS block 200 in each SS block group satisfies the performance threshold and avoid having no SS blocks 200 meeting the performance threshold in any given SS block group.

FIG. 5E illustrates a diagram 570 in which a wireless device 102 transmits PRACH preambles during multiple RACH occasions 402 associated with SS blocks 200 in different SS block groups. The wireless device 102 can measure and select multiple SS blocks 200 that each satisfy a performance threshold, where each SS block 200 is in a different SS block group and associated with different RACH occasions 402. The wireless device 102 can transmit PRACH preambles during the different RACH occasions 402 to initiate the RACH procedure and provide time diversity for reception of the PRACH preambles by the gNodeB 112. The wireless device 102 divides the SS blocks 200 into multiple SS block groups based on their associated RACH occasions 402, e.g., SS block group 0 with SS block indices 0, 1, 2, 3 and SS block group 1 with SS block indices 4, 5, 6, and 7. The wireless device 102 selects the strongest measuring SS block 200 from each SS block group as a group serving SS block. When the group serving SS block satisfies the performance threshold, RACH occasions 402 associated with the group serving SS block can be used for PRACH preamble transmission. The wireless device 102 maintains downlink timing and frequency tracking for each of the group serving SS blocks. When a RACH procedure is triggered, the wireless device 102 selects multiple RACH occasions 402 based on the group serving SS blocks that satisfy the performance threshold. The wireless device 102 selects and transmits a PRACH preamble on two (or more) RACH occasions 402, at least one from each SS block group that has a group serving SS block that satisfies the performance threshold. A RACH occasion 402 that is nearest in time to the RACH procedure trigger may be used only if there is sufficient time to prepare and transmit the PRACH preamble during the RACH occasion 402. After transmitting multiple PRACH preambles, the wireless device 102 calculates a random access radio network temporary identifier (RA-RNTI) for each PRACH preamble transmission and initiates a corresponding random access (RA) response window to monitor for a random access response (RAR) message corresponding to the PRACH preamble transmission. With multiple PRACH preamble transmissions, the wireless device 102 determines multiple RA-RNTI values and multiple RA response windows for parallel monitoring of RAR messages. When an RAR message from the gNodeB 112 is received by the wireless device 102 for one of the multiple RA-RNTI values, the wireless device 102 can discontinue monitoring of RAR messages associated with the other RA-RNTI values. By sending multiple PRACH preamble transmissions in different RACH occasions 402 (and associated with different SS blocks 200 and therefore different transmit beams), the wireless device 102 improves both latency (PRACH preambles transmitted sooner than when only one RACH occasion 402 is used) and transmit diversity (different transmit beams and RACH occasions 402 used) to improve successful performance of a RACH procedure with the gNodeB 112 of the cellular wireless network.

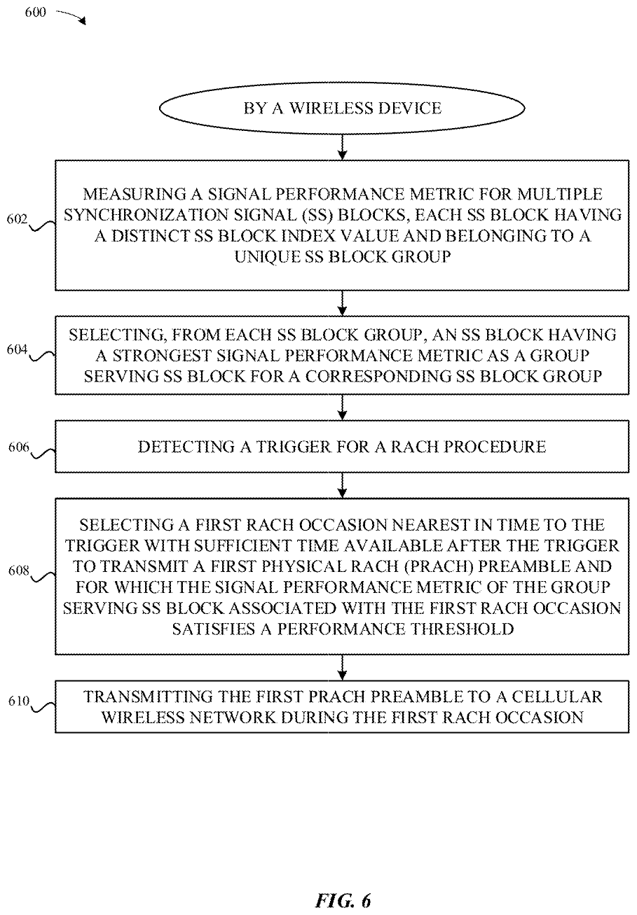

FIG. 6 illustrates a flowchart 600 of an exemplary method for using multiple SS blocks 200 by a wireless device 102 to initiate a RACH procedure. At 602, the wireless device 102 measures a signal performance metric for multiple SS blocks 200, each SS block 200 having a distinct SS block index value and belong to a unique SS block group. At 604, the wireless device 102 selects, from each SS block group, an SS block 200 having a strongest signal performance metric as a group serving SS block for a corresponding SS block group. At 606, the wireless device 102 detects a trigger for a RACH procedure. At 608, the wireless device 102 selects a first RACH occasion 402 nearest in time to the trigger with sufficient time available after the trigger to transmit a first physical RACH (PRACH) preamble and for which the signal performance metric of the group serving SS block associated with the first RACH occasion 402 satisfies a performance threshold. At 610, the wireless device 102 transmits the first PRACH preamble to a cellular wireless network during the first RACH occasion 402.

In some embodiments, the multiple SS blocks 200 are divided into distinct SS block groups, each SS block group being associated with a distinct set of non-overlapping periodic RACH occasions 402. In some embodiments, each SS block index is associated with a distinct transmit beam on which the cellular wireless network transmits the SS block 200 having the associated SS block index. In some embodiments, SS block indices of the multiple SS blocks 200 of each SS block group are assigned to distinct transmit beams to provide spatial directional diversity for transmission of the SS blocks 200. In some embodiments, SS block indices of the multiple SS blocks 200 are assigned sequentially one SS block index to each SS block group round-robin to distribute the SS blocks 200 across a widest possible transmit directional span for each SS block group. In some embodiments, the wireless device 102 maintains downlink (DL) timing and frequency tracking for each SS block group based on the group serving SS block selected for the corresponding SS block group. In some embodiments, the wireless device 102 selects a second RACH occasion 402 nearest in time to the first RACH occasion 402 and for which the signal performance metric of the SS block index value associated with the second RACH occasion 402 satisfies the performance threshold, and transmits a second PRACH preamble to the cellular wireless network during the selected second RACH occasion 402. In some embodiments, the wireless device 102: i) calculates a first random access radio network temporary identifier (RA-RNTI) for the first PRACH preamble and a second RA-RNTI for the second PRACH preamble, ii) monitors for reception of random access response (RAR) messages from the cellular wireless network during corresponding RAR windows, and iii) discontinues monitoring for the RAR messages after reception of an RAR message from the cellular wireless network responsive to the first PRACH preamble or the second PRACH preamble. In some embodiments, the first RACH occasion 402 is a RACH occasion 402 closest in time to detection of the RACH trigger by the wireless device 102. In some embodiments, the first RACH occasion 402 is a RACH occasion 402 second closest in time to detection of the RACH trigger by the wireless device 102.

### Representative Exemplary Apparatus

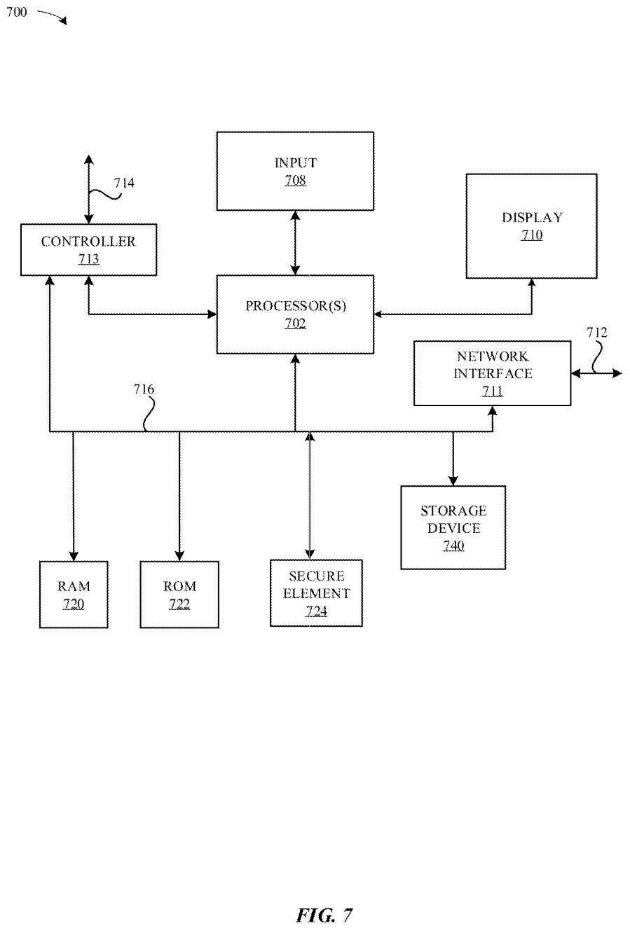

FIG. 7 illustrates in block diagram format an exemplary computing device 700 that can be used to implement the various components and techniques described herein, according to some embodiments. In particular, the detailed view of the exemplary computing device 700 illustrates various components that can be included in a wireless device 102. As shown in FIG. 7, the computing device 700 can include one or more processors 702 that represent microprocessors or controllers for controlling the overall operation of computing device 700. In some embodiments, the computing device 700 can also include a user input device 708 that allows a user of the computing device 700 to interact with the computing device 700. For example, in some embodiments, the user input device 708 can take a variety of forms, such as a button, keypad, dial, touch screen, audio input interface, visual/image capture input interface, input in the form of sensor data, etc. In some embodiments, the computing device 700 can include a display 710 (screen display) that can be controlled by the processor(s) 702 to display information to the user (for example, information relating to incoming, outgoing, or active communication sessions). A data bus 716 can facilitate data transfer between at least a storage device 740, the processor(s) 702, and a controller 713. The controller 713 can be used to interface with and control different equipment through an equipment control bus 714. The computing device 700 can also include a network/bus interface 711 that couples to a data link 712. In the case of a wireless connection, the network/bus interface 711 can include wireless circuitry, such as a wireless transceiver and/or baseband processor. The computing device 700 can also include a secure element 724. The secure element 724 can include an eUICC.

The computing device 700 also includes a storage device 740, which can include a single storage or a plurality of storages (e.g., hard drives), and includes a storage management module that manages one or more partitions within the storage device 740. In some embodiments, storage device 740 can include flash memory, semiconductor (solid state) memory or the like. The computing device 700 can also include a Random-Access Memory (RAM) 720 and a Read-Only Memory (ROM) 722. The ROM 722 can store programs, utilities or processes to be executed in a non-volatile manner. The RAM 720 can provide volatile data storage, and stores instructions related to the operation of the computing device 700.

### Wireless Terminology

In accordance with various embodiments described herein, the terms “wireless communication device,” “wireless device,” “mobile device,” “mobile station,” and “user equipment” (UE) may be used interchangeably herein to describe one or more common consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near field communication (NFC), a cellular wireless network, a fourth generation (4G) LTE, LTE Advanced (LTE-A), 5G, and/or 5G-Advanced or other present or future developed advanced cellular wireless networks.

The wireless communication device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless communication device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless communication devices that are also capable of communicating via different third generation (3G) and/or second generation (2G) RATs. In these scenarios, a multi-mode user equipment (UE) can be configured to prefer attachment to LTE networks offering faster data rate throughput, as compared to other 3G legacy networks offering lower data rate throughputs. For instance, in some implementations, a multi-mode UE may be configured to fall back to a 3G legacy network, e.g., an Evolved High Speed Packet Access (HSPA+) network or a Code Division Multiple Access (CDMA) 2000 Evolution-Data Only (EV-DO) network, when 5G, LTE and LTE-A networks are otherwise unavailable.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

1. A method for uplink (UL) random access channel (RACH) transmission by a wireless device, the method comprising:
by the wireless device:
measuring a signal performance metric for a plurality of synchronization signal (SS) blocks, each SS block having a distinct SS block index value and belonging to a unique SS block group;
selecting, from each SS block group, an SS block having a strongest signal performance metric as a group serving SS block for a corresponding SS block group;
detecting a trigger for a RACH procedure;
selecting a first RACH occasion nearest in time to the trigger with sufficient time available after the trigger to transmit a first physical RACH (PRACH) preamble and for which the signal performance metric of the group serving SS block associated with the first RACH occasion satisfies a performance threshold; and
transmitting the first PRACH preamble to a cellular wireless network during the first RACH occasion.

2. The method of claim 1, wherein the plurality of SS blocks are divided into distinct SS block groups, each SS block group associated with a distinct set of non-overlapping periodic RACH occasions.

3. The method of claim 2, wherein each SS block index is associated with a distinct transmit beam on which the cellular wireless network transmits the SS block having the associated SS block index.

4. The method of claim 3, wherein SS block indices of the plurality of SS blocks of each SS block group are assigned to distinct transmit beams to provide spatial directional diversity for transmission of the SS blocks.

5. The method of claim 3, wherein SS block indices of the plurality of SS blocks are assigned sequentially one SS block index to each SS block group round-robin to distribute the SS blocks across a widest possible transmit directional span for each SS block group.

6. The method of claim 1, further comprising:
by the wireless device:
maintaining downlink (DL) timing and frequency tracking for each SS block group based on the group serving SS block selected for the corresponding SS block group.

7. The method of claim 1, further comprising:
by the wireless device:
selecting a second RACH occasion nearest in time to the first RACH occasion and for which the signal performance metric of the SS block index value associated with the second RACH occasion satisfies the performance threshold; and
transmitting a second PRACH preamble to the cellular wireless network during the second RACH occasion.

8. The method of claim 7, further comprising:
by the wireless device:
calculating a first random access radio network temporary identifier (RA-RNTI) for the first PRACH preamble and a second RA-RNTI for the second PRACH preamble;
monitoring for reception of random access response (RAR) messages from the cellular wireless network during corresponding RAR windows; and
discontinuing monitoring for the RAR messages after reception of an RAR message from the cellular wireless network responsive to the first PRACH preamble or the second PRACH preamble.

9. The method of claim 1, wherein the first RACH occasion is a RACH occasion closest in time to detection of the trigger for the RACH procedure by the wireless device.

10. The method of claim 1, wherein the first RACH occasion is a RACH occasion second closest in time to detection of the trigger for the RACH procedure by the wireless device.

11. A wireless device comprising:
wireless circuitry comprising a plurality of antennas;
at least one processor communicatively coupled to the wireless circuitry and to a memory storing instructions that, when executed by the at least one processor, configure the wireless device to:
measure a signal performance metric for a plurality of synchronization signal (SS) blocks, each SS block having a distinct SS block index value and belonging to a unique SS block group;
select, from each SS block group, an SS block having a strongest signal performance metric as a group serving SS block for a corresponding SS block group;
detect a trigger for a RACH procedure;
select a first RACH occasion nearest in time to the trigger with sufficient time available after the trigger to transmit a first physical RACH (PRACH) preamble and for which the signal performance metric of the group serving SS block associated with the first RACH occasion satisfies a performance threshold; and
transmit the first PRACH preamble to a cellular wireless network during the first RACH occasion.

12. The wireless device of claim 11, wherein the plurality of SS blocks are divided into distinct SS block groups, each SS block group associated with a distinct set of non-overlapping periodic RACH occasions.

13. The wireless device of claim 12, wherein each SS block index is associated with a distinct transmit beam on which the cellular wireless network transmits the SS block having the associated SS block index.

14. The wireless device of claim 13, wherein SS block indices of the plurality of SS blocks of each SS block group are assigned to distinct transmit beams to provide spatial directional diversity for transmission of the SS blocks.

15. The wireless device of claim 13, wherein SS block indices of the plurality of SS blocks are assigned sequentially one SS block index to each SS block group round-robin to distribute the SS blocks across a widest possible transmit directional span for each SS block group.

16. The wireless device of claim 11, wherein the wireless device is further configured to maintain downlink (DL) timing and frequency tracking for each SS block group based on the group serving SS block selected for the corresponding SS block group.

17. The wireless device of claim 11, wherein the wireless device is further configured to:
select a second RACH occasion nearest in time to the first RACH occasion and for which the signal performance metric of the SS block index value associated with the second RACH occasion satisfies the performance threshold; and
transmit a second PRACH preamble to the cellular wireless network during the selected second RACH occasion.

18. The wireless device of claim 17, wherein the wireless device is further configured to:
calculate a first random access radio network temporary identifier (RA-RNTI) for the first PRACH preamble and a second RA-RNTI for the second PRACH preamble;
monitor for reception of random access response (RAR) messages from the cellular wireless network during corresponding RAR windows; and
discontinue monitoring for the RAR messages after reception of an RAR message from the cellular wireless network responsive to the first PRACH preamble or the second PRACH preamble.

19. The wireless device of claim 11, wherein:
the first RACH occasion is a RACH occasion closest in time to detection of the trigger for the RACH procedure by the wireless device; or
the first RACH occasion is a RACH occasion second closest in time to detection of the trigger for the RACH procedure by the wireless device.

20. (canceled)

21. (canceled)

22. An apparatus configurable for operation in a wireless device, the apparatus comprising one or more processors coupled to a memory storing instructions, wherein the apparatus is configured to:
measure a signal performance metric for a plurality of synchronization signal (SS) blocks, each SS block having a distinct SS block index value and belonging to a unique SS block group;
select, from each SS block group, an SS block having a strongest signal performance metric as a group serving SS block for a corresponding SS block group;
detect a trigger for a random access channel (RACH) procedure;
select a first RACH occasion nearest in time to the trigger with sufficient time available after the trigger to transmit a first physical RACH (PRACH) preamble and for which the signal performance metric of the group serving SS block associated with the first RACH occasion satisfies a performance threshold; and
transmit the first PRACH preamble to a cellular wireless network during the first RACH occasion.
